(19) United States
(12) Patent Application Publication
(10) Pub. No.: US 2024/0127318 A1
(43) Pub. Date: Apr. 18, 2024

(54) System and Application for Ordering and Delivering to a Remote Location

(71) Applicant: Thomas Edison, Lexington, SC (US)

(72) Inventor: Thomas Edison, Lexington, SC (US)

(21) Appl. No.: 18/483,203

(22) Filed: Oct. 9, 2023

Related U.S. Application Data
(60) Provisional application No. 63/415,745, filed on Oct. 13, 2022.

(51) Int. Cl. G06Q 30/0601; G06Q 10/0836; G06Q 50/12

(52) U.S. Cl. CPC G06Q 30/0635; G06Q 10/0836; G06Q 50/12

(57) ABSTRACT

A food ordering and delivering system is disclosed to facilitate delivery of food and beverages at a beach. The system provides a software application communicatively coupled to a server system, a user can select a restaurant and cuisine, and then order food items. A delivery partner is automatically selected by the system for delivering the ordered food to a kiosk placed at the remote location or beach wherein the kiosk includes a plurality of lockers. In some embodiments, the locker is secured and is accessible using a passcode for accessing the food stored by the delivery partner. The application displays nearby restaurants, and the system eliminates the need to bring food to the remote location or to leave the remote location to go to a restaurant.

### CROSS-REFERENCE TO RELATED APPLICATION

The present application claims priority to, and the benefit of, U.S. Provisional Application No. 63/415,745, which was filed on Oct. 13, 2022 and is incorporated herein by reference in its entirety.

### FIELD OF THE INVENTION

The present invention generally relates to the field of food ordering and delivery systems. More specifically, the present invention relates to a novel software application and associated system that enables users at remote locations (i.e., beaches) to order food from nearby restaurants. The application displays nearby restaurants and a user can place an order which is delivered by a delivery partner. A kiosk having a plurality of lockers is placed at the remote location or beach where the delivery partner keeps the ordered food item. Accordingly, the present disclosure makes specific reference thereto. Nonetheless, it is to be appreciated that aspects of the present invention are also equally applicable to others like applications, devices, and methods of manufacture.

### BACKGROUND

By way of background, many individuals enjoy being at beaches, especially during warm summer days. Sunshine, sand, and refreshing water create an appealing environment for relaxation, fun activities, and socializing. Individuals also enjoy picnics with friends, family, or colleagues at beaches. However, beaches may not always have a variety of food options available nearby. As a result, individuals who want to eat at the remote location or beach often need to pack their own food. This can include preparing sandwiches, salads, fruits, snacks, and drinks that are suitable for outdoor consumption. Preparing food items consumes a lot of time and carrying food items to beaches is not always convenient. One of the other challenges of bringing food to the remote location or beach is keeping it at the right temperature. Warm summer days can lead to quick food spoilage, especially for perishable items like dairy products and meats.

Individuals also end up going to restaurants in search of food which can spoil their time at the remote location or beach. Further, finding suitable restaurants or eateries might not be as convenient as it is in urban areas, where there are plenty of dining choices available. Conventional food delivery means do not deliver food items at beaches and therefore, individuals desire an improved method of ordering and getting food delivered at beaches.

Therefore, there exists a long-felt need in the art for a system that enables individuals to order food at beaches. There is also a long felt need in the art for a system that enables individuals to order food at beaches using a mobile application and get it delivered from nearby restaurants. Additionally, there is a long felt need in the art for a system that eliminates the need for individuals to bring their own food to beaches. Moreover, there is a long felt need in the art for a system that increases business of restaurants nearby to beaches by delivering food to individuals at beaches. Further, there is a long felt need in the art for a system that enables individuals to receive their ordered food at beaches securely and conveniently. Furthermore, there has been a long felt need in the art for a mobile application that displays available restaurants, cuisines, ratings, and other information about restaurants near to a beach. Finally, there is a long felt need in the art for a system that eliminates the need to bring food to the remote location or beach or to leave a beach or remote location to go to a restaurant.

The subject matter disclosed and claimed herein, in one embodiment thereof, comprises a food ordering and delivery system configured to facilitate users at the remote location or beach to order food and get the food delivered from nearby restaurants. The system comprises a software application, a server system, a user device, wherein the server system is communicatively coupled to the user device via a communications network, wherein the user device facilitates a user to order food items, receive the food items delivery location, and/or transmit the data using the software application, and further wherein the system provides a kiosk having a secure locker for storing the ordered food items. A delivery partner is automatically selected for picking up orders from the restaurant and delivering same to the kiosk.

In this manner, the food ordering and delivery system of the present invention accomplishes all of the forgoing objectives and provides users with a software application capable of ordering food from restaurants near to a beach. The system enables secure delivery to a kiosk placed at a beach and eliminates the need to bring food to the remote location or beach or to leave a beach or remote location to go to a restaurant.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a server system connected to a plurality of remote electronic devices for providing food ordering and delivery. The server system comprising a plurality of electronic devices connected with an internet communication network and an application installed in a user device, wherein the application installed on the user device for displaying user interfaces enabling a user to access the server system, wherein the user device includes a non-transient and tangible machine for executing a machine-readable code to register a user, select a restaurant, select a food item and place an order, receiving an identifier of a kiosk and a locker wherein the ordered food is stored by a delivery partner. The machine-readable code provides a passcode enabling a user to open the locker for accessing the ordered food.

In yet another embodiment, a method of ordering food items and getting the items delivered at a beach is described. The method comprising the steps of using a non-transient and tangible machine installed in a user device for ordering food items from a restaurant; receiving, by the non-transient and tangible machine, a location of a kiosk and a locker of the kiosk in which the food items are dropped off by a delivery partner; receiving, by the a non-transient and tangible machine, a passcode to unlock the locker; unlocking the locker by entering the passcode using a touchpad disposed on the locker and accessing the ordered food items from the locker.

In yet another embodiment, a food ordering and delivery system configured to facilitate users to order food and get the food delivered at a beach is disclosed. The system comprises a software application, a server system, a user device, wherein the server system is communicatively coupled to the user device via a communications network, wherein the user device facilitates a user to order food items, receive the food items delivery location, and/or transmit the data using the software application, and further wherein the system provides a kiosk having a secure locker for storing the ordered food items.

In yet another embodiment, a delivery partner is automatically selected based on location of the restaurant from which the food item is ordered by a user and the food item is delivered to a kiosk placed at a beach wherein the kiosk has a plurality of lockers.

The advantages of the device of the present invention are that it enables users with a mobile software app capable of ordering food from nearby restaurants while at a beach. The invention includes a kiosk with several lockers that can accommodate food deliveries to any patron who order food on the application. The invention eliminates the need to bring food to the remote location or beach or to leave a beach or remote location to go to a restaurant.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters. refer to similar parts throughout the different views, and in which:

FIG. 1 is a schematic diagram illustrating one potential embodiment of a food delivery system of the present invention for delivering food to a beach or remote location in accordance with the disclosed structure;

FIG. 2 illustrates an exemplary flow chart that illustrates steps of displaying various restaurants in the software application of the present invention in accordance with the disclosed structure;

FIG. 3 illustrates an exemplary user interface displayed by the software application for displaying different food items for selection by a user in accordance with the disclosed structure;

FIG. 4 illustrates an exemplary flow chart that illustrates steps of ordering food and providing real time updates about the order in the software application of the present invention in accordance with the disclosed structure;

FIG. 5 illustrates an exemplary flow chart that illustrates steps of providing locker and passcode information in the software application for accessing ordered food dropped off by a delivery partner in accordance with the disclosed structure;

FIG. 6 illustrates a flow chart depicting the steps of a process of accessing ordered food items from the kiosk by a patron in accordance with the disclosed architecture;

FIG. 7 is an exemplary user interface showing a map displaying the current location of the patron and the nearest kiosk in which the food is delivered by a delivery partner in accordance with the disclosed architecture;

FIG. 8 illustrates a patron/customer picking up their order from the kiosk wherein the food is dropped off by a delivery partner in accordance with the disclosed architecture;

FIG. 9 illustrates a front view of the locker of the kiosk showing the touchscreen, keypad, and an indicator LED in accordance with the disclosed structure; and

FIG. 10 illustrates a patron using the application at the beach and a nearby kiosk is positioned at the beach in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a system that enables individuals to order food at beaches. There is also a long felt need in the art for a system that enables individuals to order food at beaches using a mobile application and get same delivered from nearby restaurants. Additionally, there is a long felt need in the art for a system that eliminates the need for individuals to bring their own food to beaches. Moreover, there is a long felt need in the art for a system that increases business of restaurants nearby beaches by delivering food to individuals at beaches. Further, there is a long felt need in the art for a system that enables individuals to receive their ordered food at beaches securely and conveniently. Furthermore, there is a long felt need in the art for a mobile application that displays available restaurants, cuisines, ratings, and other information about restaurants near or proximal to a beach. Finally, there is a long felt need in the art for a system that eliminates the need to bring food to the remote location or beach or to leave a beach or remote location to go to a restaurant.

The present invention, in one exemplary embodiment, is a server system connected to a plurality of remote electronic devices for providing food ordering and delivery. The server system comprising a plurality of electronic devices connected with an internet communication network and an application installed in a user device, wherein the application installed on the user device for displaying user interfaces enabling a user to access the server system, wherein the user device includes a non-transient and tangible machine for executing a machine-readable code to register a user, select a restaurant, select a food item and place an order, receiving an identifier of a kiosk and a locker wherein the ordered food is stored by a delivery partner. The machine-readable code provides a passcode enabling a user to open the locker for accessing the ordered food.

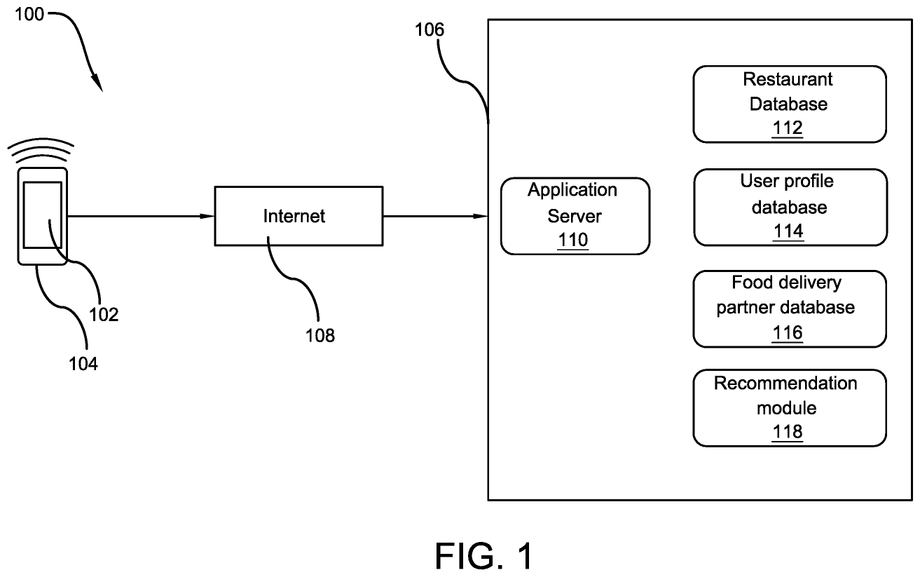

Referring initially to the drawings, FIG. 1 is a schematic diagram illustrating one potential embodiment of a food delivery system 100 of the present invention for delivering food to a beach or remote location in accordance with the disclosed structure. The system 100 of the present invention is configured to enable individuals to order food and get it delivered to a beach or remote location. Ordering and receiving food at a beach or remote location enables individuals to enjoy food without requiring them to search for food or carrying it with themselves. More specifically, the system 100 has a client-server architecture wherein a user accesses the system 100 and its offerings through a multifunctional software application 102 installed on a handheld user device 104.

The system 100 has a server system 106, that is coupled with one or more user devices 104 via a communication network 108 such as the Internet. The application 102 installed in the user device 104 is capable of displaying different user interfaces enabling a user to access food ordering and delivering capabilities offered by the system 100. It will be apparent to a person of ordinary skill in the art that the user may be any individual using the system 100. Examples of the user device 104 may include, but are not limited to, a desktop computer, a handheld computer, a touch sensitive device, a smartphone, a smartwatch, and more.

The server system 106 includes an application server 110 that is configured to provide an interface with the application 102. The application server 110 includes different logic, instructions, circuitry, interfaces and/or codes for executing various operations required for communication between the server system 106 and user device 104. The server system 106 can be a cloud-based computer (e.g., Amazon EC2), a mainframe computer system, a grid-computer system, or any other suitable computer system.

A restaurant database 112 is included in the server system 106 and stores details of different restaurants, food trucks, eating points, and more. The database 112 is configured to store various details such as name, location, cuisines, prices, associated ratings given by customers and more. The information is updated in real time and can be retrieved from third-party sources as well. In some embodiments, the restaurant owners are provided with the application 102 with a privileged right to update information such name, location, timings, cuisines, and prices. It should be understood that embodiments of the present disclosure are intended to include and/or otherwise cover any type of the data associated with the restaurants/food trucks/eating junctions registered with the system 100.

A user profile database 114 stores information of registered users of the system 100. A user ordering the food using the application 102 for the first time is required to register in the application 102 by providing information such as name, age, taste preferences (such as sea food, vegan, egg, and more). The information stored in the database 114 is also used for providing cuisine and restaurant recommendations to the users. It should be understood that embodiments of the present disclosure are intended to include and/or otherwise cover any type of the data associated with the users registered with the system 100.

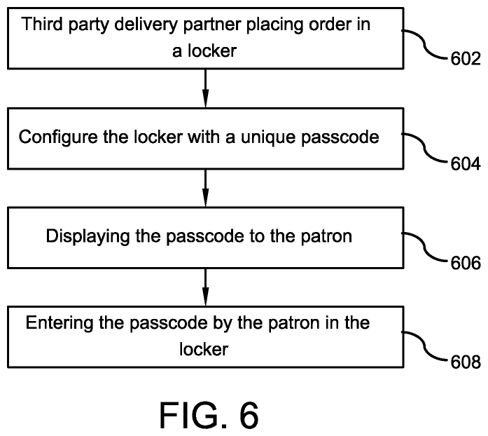

A food delivery partners database 116 is configured to store details of various delivery partners registered for delivering food ordered by users. The delivery partners can be individuals or third-party delivery services such as Uber and more. The food delivery partners based on their current location receive order information for pick up from a restaurant and delivery of same to the user who ordered the order and to the remote location designated. A background check is completed for food delivery partners before registering in the system 100. It should be understood that embodiments of the present disclosure are intended to include and/or otherwise cover any type of the data associated with the delivery partners registered with the system 100. The food is delivered to a kiosk placed at a beach as described in FIGS. 6-9 for easy, secure, and convenient delivery thereof without requiring face-to-face communication from an ordering user and a delivery partner delivering the ordered food.

A recommendation module 118 is used for recommending cuisines and restaurants to users based on their taste preferences, past orders, restaurants ratings, and cuisines. The recommendation module 118 uses the information stored in the databases 112, 114 for providing customized recommendation to users.

The communication network 108 may include suitable logic, circuitry, and interfaces that may be configured to provide a plurality of network ports and a plurality of communication channels for transmission and reception of data related to operations of various entities (such as the user device 104 and the server system 106) of the food ordering and delivery system 100. The communication network 108 may be associated with an application layer for implementation of communication protocols based on one or more communication requests from the user device 104 and the server system 106. The communication data may be transmitted or received, via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols, or any combination thereof.

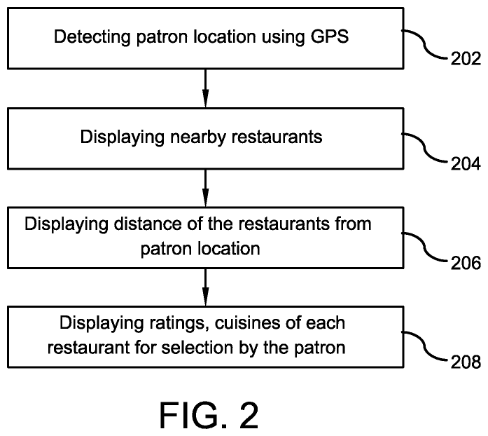

FIG. 2 illustrates an exemplary flow chart that illustrates steps of displaying various restaurants in the software application of the present invention in accordance with the disclosed structure. The software application 102 is configured to detect location information of the user device 104 in which the application 102 is installed using GPS or any other similar location detecting technology (Step 202). Based on the detected location, nearby restaurants, eating points, food trucks, and more are displayed by the software application (Step 204). It will be apparent to a person skilled in the art, that a user can choose a geo-radius such as 2 miles, 3 miles, and more in the software application 102 enabling the system 100 to display restaurants and more from within the specified distance.

The distance between each displayed restaurant and location of the ordering user (patron) is also displayed by the software application (Step 206). The displayed restaurants can be filtered based on the cuisine types and more. Finally, the ratings, cuisines, and other information pertaining to the restaurants are displayed by the software application (Step 208). Based on the displayed information, one or more restaurants can be selected by the patron for ordering food and delivered to a kiosk placed at the remote location or beach. All the information and the transactions are encrypted and secured and are communicated using at least SSL encryption.

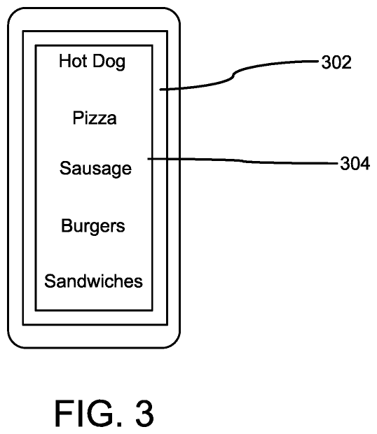

FIG. 3 illustrates an exemplary user interface displayed by the software application for displaying different food items for selection by a user in accordance with the disclosed structure. As illustrated, the application 102 provides the user interface 302 which displays a plurality of food items 304 offered by restaurants registered in the system 100. It will be apparent to a person skilled in the art that the food items/cuisines can be updated in real time to include additional food items. Any of the food items displayed on the user interface 302 can be selected by a patron and restaurants offering the selected food items are displayed by the software application 102.

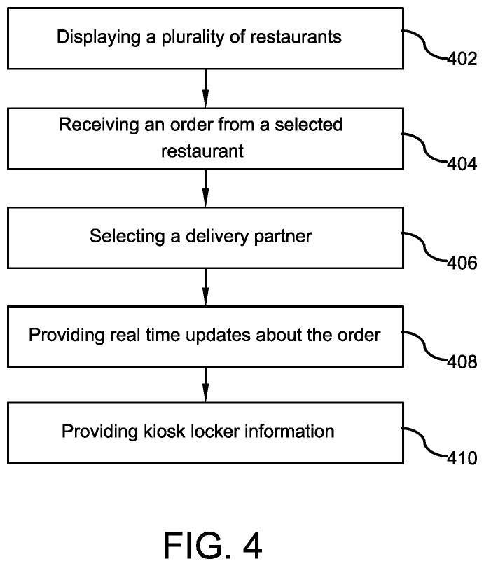

FIG. 4 illustrates an exemplary flow chart that illustrates steps of ordering food and providing real time updates about the order in the software application of the present invention in accordance with the disclosed structure. Initially, the application 102 displays a plurality of nearby restaurants (i.e., within a predeterminable distance from the kiosk) as described in FIGS. 2 and 4 (Step 402). The restaurants can be displayed as a list, as a grid, or in any appropriate format for easy visibility and selection. Then, an order is received by the system wherein a patron selects a restaurant from the list and selects one or more food items, beverages, and more and places the order by paying successfully (Step 404).

The system 100 automatically selects a delivery partner for delivering the order to a kiosk placed at a beach (Step 406). The delivery partner can be selected based on distance between the current location of the delivery partner and the restaurant at which the order is placed by the patron. Then, the application 102 provides real time updates in the form of both of audible and visual notifications such as in the form of SMS, instant message, push notification and more (Step 408). In some embodiments, the application 102 provides a chat functionality enabling the patron to chat with both the restaurant and the selected delivery partner.

A kiosk locker information is provided by the software application 102 enabling the ordering patron to easily identify the locker in which the order food is left by the delivery partner (Step 410). A plurality of kiosks may be placed at different locations at a beach for providing easy accessibility of the food by the patrons.

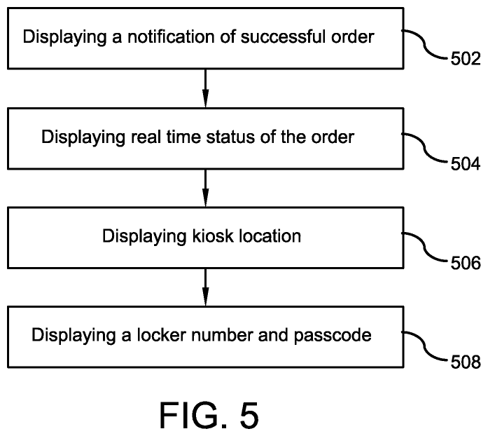

FIG. 5 illustrates an exemplary flow chart that illustrates steps of providing locker and passcode information in the software application for accessing ordered food dropped off by a delivery partner in accordance with the disclosed structure. Initially, a notification which can be one or both audible and visual, of a successfully placed order is displayed by the application (Step 502). Then, the real time status of the order is displayed by the application (Step 504).

Then, a kiosk location and associated information such as kiosk name is displayed by the application (Step 506). In the present invention, a plurality of kiosks are placed by operators of the system 100 and each kiosk has a plurality of lockers. Once a delivery partner, drops the ordered food in a locker, kiosk location is displayed and locker number and a secure passcode is displayed (Step 508). The passcode is used for opening the locker securely and prevents the food from being stolen. In some of the embodiments of the present invention, passcode may not be required and the lockers can be open lockers.

FIG. 6 illustrates a flow chart depicting the steps of a process of accessing ordered food items from the kiosk by a patron in accordance with the disclosed architecture. Initially, a third-party delivery partner places the ordered food items in a locker of a kiosk (Step 602). In preferred embodiment of the present invention, the kiosk in which the delivery partner places the food items is the one closest to the location of the ordering patron. The location of the kiosk closest to the patron is displayed to the delivery partner in the application and real-time navigation to the kiosk can also be displayed.

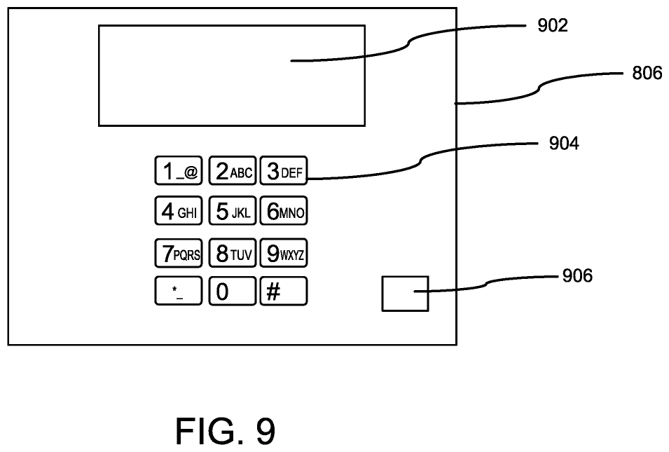

The delivery partner places the food in a locker in the kiosk and secures or locks the locker with a passcode (Step 604). The passcode can be a predetermined passcode provided to the delivery partner for locking the locker. Once, the order is placed in the locker, the passcode is displayed on the software application 102 (Step 606). Thereafter, for accessing the food by the patron, the passcode is entered in the locker as described in FIG. 9 for unlocking the locker and accessing the food (Step 608).

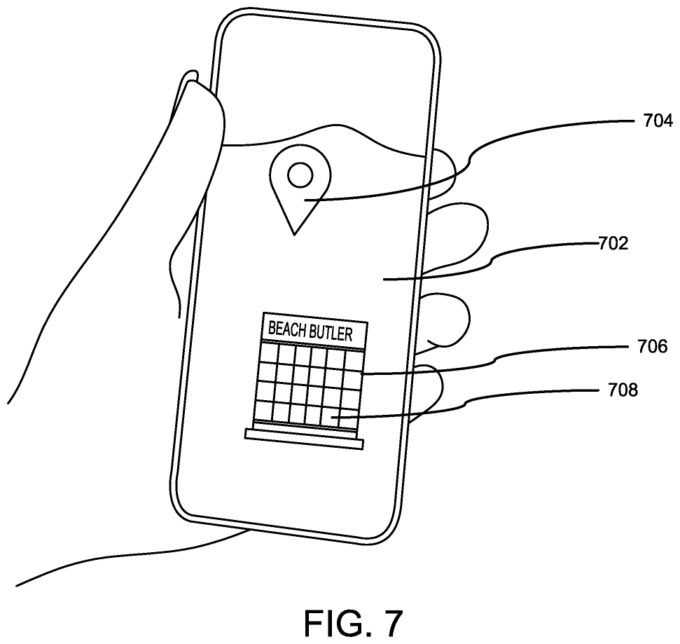

FIG. 7 is an exemplary user interface showing a map displaying the current location of the patron and the nearest kiosk in which the food is delivered by a delivery partner in accordance with the disclosed architecture. The user interface 702 displays the current location 704 of the patron and the nearest kiosk location 706 in which the food is delivered. The locker in which the food is dropped off by the delivery partner can be highlighted by the application such as shown through the highlighted locker 708.

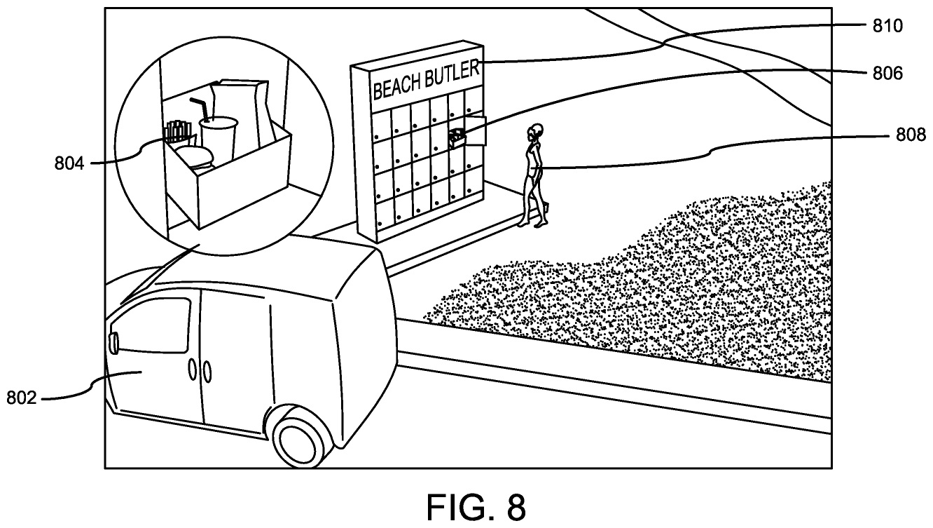

FIG. 8 illustrates a patron/customer picking up their order from the kiosk wherein the food is dropped off by a delivery partner in accordance with the disclosed architecture. As illustrated, a delivery partner 802 drops the ordered food 804 in a locker 806 which can be any free locker or alternatively, can be a predetermined locker such as of a specific restaurant. The customer or patron 808 opens the locker 806 as described in FIG. 6 to access the food items 804. It should be appreciated that the application 102 can display real time navigation to the customer 808 up to the location of the kiosk 810. The kiosks can be placed at predetermined locations at the remote location or beach.

FIG. 9 illustrates a front view of the locker of the kiosk showing the touchscreen, keypad, and an indicator LED in accordance with the disclosed structure. The locker 806 has a touchscreen display 902 for indicating name of the customer whose order is placed inside the locker 806. A keypad 904 is disposed for enabling a user to input the passcode for unlocking the locker 806 for accessing the food stored therein. An indicator LED 906 illuminates in red color when the locker 806 is occupied and can be illuminated in a different color such as green when it is free to indicate to a delivery partner about the empty state of the locker 806. In some of the embodiments, the touchscreen 902 can also be used for advertising and marketing purposes of restaurants.

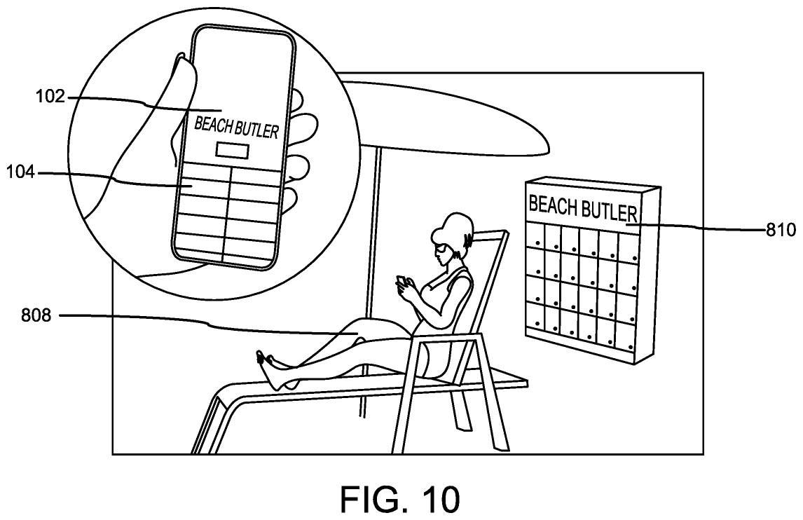

FIG. 10 illustrates a patron using the application at the remote location or beach and a nearby kiosk is positioned at the remote location or beach in accordance with the disclosed architecture. The patron 808 selects restaurants, cuisines, and orders food and beverages using the application 102 installed in the user device 104. The food is delivered in the kiosk 810 placed at a predetermined location at the remote location or beach and accessed by the customer 808 as illustrated in FIGS. 6-9.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “system”, “food delivery system”, and “food ordering and delivery system” are interchangeable and refer to the food ordering and delivery system 100 of the present invention. Similarly, as used herein “multifunctional software application”, “software application”, and “application” are interchangeable and refer to the multifunctional software application 102 of the present invention.

Notwithstanding the forgoing, the food ordering and delivery system 100 and the multifunctional software application 106 of the present invention can be of any suitable configuration as is known in the art without affecting the overall concept of the invention, provided that it accomplishes the above stated objectives. One of ordinary skill in the art will appreciate that the configuration and specification of the components of the food ordering and delivery system 100 and the multifunctional software application 106 as shown in the FIGS. are for illustrative purposes only, and that many other configurations of the food ordering and delivery system 100 and the multifunctional software application 106 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A remote ordering and remote delivery system comprising:
a remote ordering system having a client-server software application installed on a handheld user device for a user to access said remote ordering system;
wherein said remote ordering system having a search feature for searching nearby retail outlets for receiving an order and a delivery feature for coordinating a deliverer to deliver said order to a remote location; and
further wherein said remote location having a kiosk including a locker for storing said order.

2. The remote delivery system of claim 1, wherein said order is a food order.

3. The remote delivery system of claim 2, wherein said remote location is a beach location.

4. The remote delivery system of claim 3, wherein said locker having a passcode shared between said deliverer and said user.

5. The remote delivery system of claim 4, wherein said remote ordering system connected to a server system and said handheld user device.

6. The remote delivery system of claim 5, wherein said server system having a communication network including an Internet network.

7. The remote delivery system of claim 6, wherein said user device selected from a group consisting of a desktop computer, a handheld computer, a touch sensitive device, a smartphone, and a smartwatch.

8. The remote delivery system of claim 1, wherein said server system having a restaurant database and said order is a food order.

9. The remote delivery system of claim 8, wherein said client-server software application displaying a distance between said restaurant and said remote location.

10. The remote delivery system of claim 9, wherein said client-server software application displaying all restaurants within a determinable distance from said remote location.

11. A remote ordering and remote delivery system comprising:
a remote ordering system having a client-server software application installed on a handheld user device for a user to access said remote ordering system;
wherein said remote ordering system having a search feature for searching nearby retail outlets for receiving an order and a delivery feature for coordinating a deliverer to deliver said order to a remote location;
wherein said remote location having a kiosk including a locker for storing said order;
wherein said server system having a restaurant database and said order is a food order;
wherein said locker having a passcode shared between said deliverer and said user; and
further wherein said client-server software application displaying all restaurants within a determinable distance from said remote location.

12. The remote delivery system of claim 11, wherein said remote location is a beach location.

13. The remote delivery system of claim 12, wherein said remote ordering system connected to a server system and said handheld user device.

14. The remote delivery system of claim 13, wherein said server system having a communication network including an Internet network.

15. The remote delivery system of claim 14, wherein said user device selected from a group consisting of a desktop computer, a handheld computer, a touch sensitive device, a smartphone, and a smartwatch.

16. The remote delivery system of claim 11, wherein said client-server software application displaying a distance between said restaurant and said remote location.

17. A method for remote ordering and remote delivering, the method comprising the steps of:
providing a remote ordering system having a client-server software application installed on a handheld user device for a user to access said remote ordering system, wherein said remote ordering system having a search feature for searching nearby retail outlets for receiving an order and a delivery feature for coordinating a deliverer to deliver said order to a remote location, further wherein said remote location having a kiosk including a locker for storing said order;
ordering said order for said delivery of said order to said locker at said remote location, wherein said server system having a restaurant database and said order is a food order;
delivering said order to said locker;
entering a passcode into said locker for securing said order in said locker; and
sharing said passcode of said locker to said user for accessing said order by said user.

18. The method for remote ordering and remote delivering of claim 17 further comprising a step of displaying all restaurants on said handheld user device within a determinable distance from said remote location.

19. The method for remote ordering and remote delivering of claim 17, wherein said remote location is a beach location.

20. The method for remote ordering and remote delivering of claim 19, wherein said client-server software application displaying a distance between said restaurant and said remote location.
